(19) United States
(12) Patent Application Publication
(10) Pub. No.: US 2024/0265334 A1
(43) Pub. Date: Aug. 8, 2024

(54) SYSTEM AND COMPUTER-IMPLEMENTED METHOD FOR AUTOMATED GENERATION OF AI-ENABLED INSPECTION REPORTS FOR CROSS-BORDER TRADE

(71) Applicant: Azam Pasha, Dubai (AE)

(72) Inventors: Azam Pasha, Dubai (AE); Rohit Majhi, Pune (IN)

(21) Appl. No.: 18/430,272

(22) Filed: Feb. 1, 2024

Related U.S. Application Data
(60) Provisional application No. 63/442,941, filed on Feb. 2, 2023.

(51) Int. Cl. G06Q 10/0831; G06Q 10/0635; G06Q 30/018

(52) U.S. Cl. CPC G06Q 10/0831; G06Q 10/0635; G06Q 30/018

(57) ABSTRACT

Embodiments of the present invention provides a system for automated generation of AI-enabled inspection reports for cross-border trade of food and agriproducts, comprising one or more inspection devices associated with inspectors; an Internet of Things (IoT) module to gather shipment related data as IoT data; a blockchain framework for securing all data; and a computer system connected with the one or more inspection devices, the IoT module and the blockchain framework. The computer system is configured to receive photographic data related to the shipment from the one or more inspection devices; integrate the photographic data with IoT data; analyze the integrated data using AI models to assess Quality, Quantity, and Weight (QQW) risks; and generate inspection reports based on the AI analysis. The generated inspection reports are envisaged to detail the QQW risks for stakeholders in the cross-border trade and therefore, wirelessly, shared with stakeholder devices.

### CROSS REFERENCE TO RELATED APPLICATION

The present application is a non-provisional application based on, and claims priority from U.S. patent application Ser. No. 63/442,941, filed on Feb. 2, 2023.

### TECHNICAL FIELD

Embodiments of the present invention generally relate to trade and finance technologies and more particularly to a system and a computer-implemented method for automated generation of AI-enabled inspection reports for cross-border trade of food and agriproducts.

### BACKGROUND OF THE INVENTION

The subject matter discussed in the background section should not be assumed to be prior art merely as a result of it being mentioned in the background section. Similarly, a problem mentioned in the background section or associated with the subject matter of the background section should not be assumed to have been previously recognized in the prior art. The subject matter in the background section merely represents different approaches, which in and of themselves may also correspond to implementations of the claimed technology.

In the dynamic sector of cross-border trade, specifically focusing on the trade of food and agriproducts among small and medium-sized businesses, ensuring the quality, quantity, and adherence to specified standards of the products is paramount. Traditionally, this verification process has been reliant on manual inspections conducted by inspectors at shipment or delivery locations. However, manual inspections are time-consuming and susceptible to human error, which can lead to inconsistencies and disputes, adversely affecting the trade process.

There has been a growing need to modernize the inspection process to handle the increasing volume and complexity of international trade. This modernization involves incorporating technological advancements to enhance the accuracy and efficiency of inspections. The advent of artificial intelligence (AI) offers a promising avenue for analyzing photographic data to assess quality parameters quickly and consistently. Moreover, the Internet of Things (IoT) enables the collection of real-time data that provides additional layers of verification, such as environmental conditions affecting the products during shipment.

However, integrating these technologies into a coherent system that can automate the generation of inspection reports while ensuring data integrity and compliance with international trade standards still remains a big challenge. Even with all the technologies that we have at our disposal now, there is a particular gap in this field. Still there are no provisions available to create comprehensive inspection reports that can mitigate risks associated with the quality, quantity, and weight (QQW) of traded goods.

Thus, there is a need for a system and a computer-implemented method for automated generation of AI-enabled inspection reports for cross-border trade of food and agriproducts. Such a solution should offer an integrated system that can leverage AI and IoT technologies to generate instant, accurate, and reliable inspection reports that support stakeholders in making informed decisions, ensuring compliance, and minimizing disputes in the cross-border trade of food and agriproducts.

### SUMMARY OF THE INVENTION

According to a first aspect of the present invention, there is provided a system for automated generation of AI-enabled inspection reports for cross-border trade of food and agriproducts. The system comprises, but not limited to, one or more inspection devices associated with inspectors; an Internet of Things (IoT) module to gather shipment related data as IoT data; a blockchain framework for securing all data; and a computer system connected with the one or more inspection devices, the IoT module and the blockchain framework. Herein, the computer system includes, but not limited to, a processor; and a memory unit configured to store machine readable instructions that, when executed by the processor, cause the computer system to, but not limited to, receive photographic data related to the shipment from the one or more inspection devices; integrate the photographic data with IoT data; analyze the integrated data using artificial intelligence (AI) models to assess Quality, Quantity, and Weight (QQW) risks; and generate inspection reports based on the AI analysis.

In accordance with an embodiment of the present invention, the one or more inspection devices are selected from a group comprising digital cameras and video recorders.

In accordance with an embodiment of the present invention, the IoT data includes at least temperature, location, and humidity data collected during shipment.

In accordance with an embodiment of the present invention, the blockchain framework comprises an immutable ledger configured to securely log inspection data.

In accordance with an embodiment of the present invention, the AI models include image recognition algorithms configured to analyze photographic data.

In accordance with an embodiment of the present invention, the generated inspection reports are configured to detail the QQW risks for stakeholders in the cross-border trade.

In accordance with an embodiment of the present invention, the computer system further comprises a communication module configured to transmit the integrated data and inspection reports wirelessly.

In accordance with an embodiment of the present invention, the computer system is further configured to update the inspection reports in real-time as new data is received.

In accordance with an embodiment of the present invention, the inspection reports are configured to be accessed via user interfaces on associated stakeholder devices.

In accordance with an embodiment of the present invention, the stakeholder devices are selected from a group comprising laptops, mobile phones, wearable watches or bands, desktop computers, and portable handheld devices with computing capabilities.

According to a second aspect of the present invention, there is provided a computer-implemented method for automated generation of AI-enabled inspection reports for cross-border trade of food and agriproducts. The computer-implemented method comprises, but not limited to, receiving photographic data related to the shipment from one or more inspection devices associated with inspectors; integrating the photographic data with IoT data from an IoT module; analyzing the integrated data using artificial intelligence (AI) models to assess Quality, Quantity, and Weight (QQW) risks; and generating inspection reports based on the AI analysis.

In accordance with an embodiment of the present invention, receiving photographic data includes capturing images and videos at shipment or delivery locations.

In accordance with an embodiment of the present invention, the IoT data includes at least temperature, location, and humidity data.

In accordance with an embodiment of the present invention, the computer-implemented method further comprises securing the integrated data using a blockchain framework.

In accordance with an embodiment of the present invention, analyzing the integrated data includes using machine learning techniques for image and pattern recognition.

In accordance with an embodiment of the present invention, generating inspection reports includes detailing the assessed QQW risks.

In accordance with an embodiment of the present invention, the computer-implemented method further comprises wirelessly transmitting the integrated data and inspection reports to associated stakeholder devices.

In accordance with an embodiment of the present invention, the computer-implemented method further comprises updating the inspection reports in real-time as new data is received.

In accordance with an embodiment of the present invention, the computer-implemented method further comprises accessing the inspection reports via user interfaces on associated stakeholder devices.

In accordance with an embodiment of the present invention, the associated stakeholder devices are selected from a group comprising laptops, mobile phones, wearable watches or bands, desktop computers, and portable handheld devices with computing capabilities.

### BRIEF DESCRIPTION OF THE DRAWINGS

So that the manner in which the above recited features of the present invention can be understood in detail, a more particular description of the invention, briefly summarized above, may have been referred by embodiments, some of which are illustrated in the appended drawings. It is to be noted, however, that the appended drawings illustrate only typical embodiments of this invention and are therefore not to be considered limiting of its scope, for the invention may admit to other equally effective embodiments.

These and other features, benefits, and advantages of the present invention will become apparent by reference to the following text figure, with like reference numbers referring to like structures across the views, wherein:

FIG. 1 illustrates a system for automated generation of AI-enabled inspection reports for cross-border trade of food and agriproducts, in accordance with an embodiment of the present invention;

FIG. 2 illustrates a method for automated generation of AI-enabled inspection reports for cross-border trade of food and agriproducts, in accordance with an embodiment of the present invention; and

FIG. 3 illustrate information flow diagram showcasing an exemplary implementation of the system and method of FIGS. 1 and 2, in accordance with an embodiment of the present invention.

### DETAILED DESCRIPTION OF THE DRAWINGS

While the present invention is described herein by way of example using embodiments and illustrative drawings, those skilled in the art will recognize that the invention is not limited to the embodiments of drawing or drawings described and is not intended to represent the scale of the various components. Further, some components that may form a part of the invention may not be illustrated in certain figures, for ease of illustration, and such omissions do not limit the embodiments outlined in any way. It should be understood that the drawings and detailed description thereto are not intended to limit the invention to the particular form disclosed. Still, on the contrary, the invention is to cover all modifications, equivalents, and alternatives falling within the scope of the present invention as defined by the appended claims. As used throughout this description, the word “may” is used in a permissive sense (i.e., meaning having the potential to), rather than the mandatory sense, (i.e., meaning must). Further, the words “a” or “an” mean “at least one” and the word “plurality” means “one or more” unless otherwise mentioned. Furthermore, the terminology and phraseology used herein are solely used for descriptive purposes and should not be construed as limiting in scope. Language such as “including,” “comprising,” “having,” “containing,” or “involving,” and variations thereof, is intended to be broad and encompass the subject matter listed after that, equivalents, and additional subject matter not recited, and is not intended to exclude other additives, components, integers or steps. Likewise, the term “comprising” is considered synonymous with the terms “including” or “containing” for applicable legal purposes. Any discussion of documents, acts, materials, devices, articles, and the like is included in the specification solely to provide a context for the present invention. It is not suggested or represented that any or all of these matters form part of the prior art base or were common general knowledge in the field relevant to the present invention.

In this disclosure, whenever a composition or an element or a group of elements is preceded with the transitional phrase “comprising”, it is understood that we also contemplate the same composition, element, or group of elements with transitional phrases “consisting of”, “consisting”, “selected from the group of consisting of, “including”, or “is” preceding the recitation of the composition, element or group of elements and vice versa.

The present invention is described hereinafter by various embodiments with reference to the accompanying drawing, wherein reference numerals used in the accompanying drawing correspond to the like elements throughout the description. This invention may, however, be embodied in many different forms and should not be construed as limited to the embodiment set forth herein. Rather, the embodiment is provided so that this disclosure will be thorough and complete and will fully convey the scope of the invention to those skilled in the art. In the following detailed description, numeric values and ranges are provided for various aspects of the implementations described. These values and ranges are to be treated as examples only and are not intended to limit the scope of the claims.

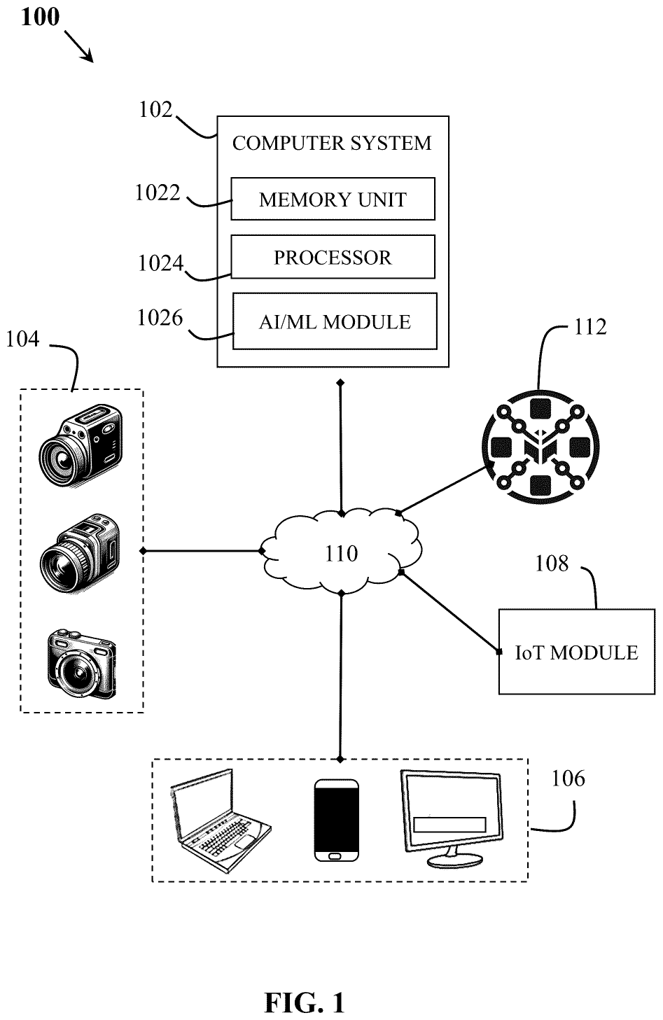

Referring to the drawings, the invention will now be described in more detail. FIG. 1 illustrates a system 100 for evaluating and scoring small businesses engaged in cross-border trade, in accordance with an embodiment of the present invention. As shown in FIG. 1, the system 100 comprises, but is not limited to, one or more inspection devices 104 associated with inspectors; an Internet of Things (IoT) module 108 to gather shipment related data as IoT data; a blockchain framework 112 for securing all data; and a computer system 102 connected with the one or more inspection devices 104, the IoT module 108, and the blockchain framework 112, via a communication network 110. In one embodiment, the computer system 102 is a stand-alone device managed by inspectors, to generate inspection reports.

In another embodiment, the computer system 102 may be associated with a trade facilitation platform that facilitates cross-border trade of food and agriproducts, where generation of inspection reports is a part of the trade process. In such embodiments, the trade facilitation platform serves as a digital nexus for streamlining cross-border trade of food and agriproducts and is designed to act as a comprehensive marketplace, bringing together buyers and sellers from diverse geographic locations, enabling them to engage in trade with greater confidence and reduced risk. The platform is capable of running on Windows, macOS, Linux, or various mobile operating systems, thereby ensuring flexibility to operate on different devices as well as consistent performance and user experience across different technological environments. This capability ensures that stakeholders can rely on the platform 101 for their inspection report requirements regardless of their preferred technology ecosystem.

Returning to FIG. 1, the depicted embodiment includes various hardware components that are integral to the system's 100 operation, each with distinct capabilities and connections to other components within the system 100. Each component will now be discussed in detail below:

As can be seen from the FIG. 1, the brain of the system 100 is the computer system 102. In that sense, the computer system 102 may be envisioned as the central processing unit of the system 100. It comprises a processor 1024 and a memory unit 1022. The processor 1024 is a critical component that executes machine-readable instructions stored within the memory unit 1022. The processor 1024 may be one of, but not limited to, a general-purpose processor, an application-specific integrated circuit (ASIC), or a field-programmable gate array (FPGA).

The memory unit 1022 of the computer system 102 is configured to store machine-readable instructions that, when executed by the processor 1024, enable the computer system 102 to perform a multitude of functions relevant to the inspection report generation process. The memory unit 1022 can be selected from a group comprising, but not limited to, Electrically Programmable Read-Only Memory (EPROM), Electrically Erasable Programmable Read-Only Memory (EEPROM), and Flash memory. The memory unit 1022 can be loaded with machine-readable instructions from a non-transitory machine-readable medium, such as, but not limited to, CD-ROMs, DVD-ROMs, and Flash Drives. Alternatively, the machine-readable instructions can be loaded in the form of a computer software program into the memory unit 1022.

The computer system 102 is equipped with a communication module, pivotal for enabling robust wireless connections across the system's various components, although not depicted in FIG. 1. This module is central to the operation of the system 100, facilitating efficient and secure data transfer and interactions between the computer system 102, the one or more inspection devices 104, the IoT module 108, and the blockchain framework 112, via the communication network 110. The communication module's wireless capabilities are essential for the real-time data processing and secure data handling that the automated inspection report generation system 100 requires. It supports a range of wireless communication protocols, including Wi-Fi, Bluetooth, and NFC (Near Field Communication), to provide flexible and robust connectivity options. Such protocols are instrumental for the computer system 102 to maintain continuous and reliable wireless connections, which are vital for the dynamic and real-time functionalities integral to the automated generation of inspection reports.

In that sense, the communication network 110 can be a short-range communication network 110 and/or a long-range communication network 110. The communication interface includes, but is not limited to, a serial communication interface, a parallel communication interface, or a combination thereof. The communication network 110 enables the seamless transfer of data and instructions between the components of the system 100. It may utilize various communication protocols and technologies, including, but not limited to, the Internet, intranets, virtual private networks (VPNs), and cloud-based services, ensuring that the system 100 remains connected and responsive to the needs of the users.

The system 100 incorporates one or more inspection devices 104, associated with inspectors responsible for the collection of photographic data crucial to the inspection process. These inspection devices 104, which may include, but are not limited to, digital cameras and video recorders, are designed to capture high-quality images and videos at shipment or delivery locations. The photographic data acquired by these devices is a vital component in the evaluation of Quality, Quantity, and Weight (QQW) risks associated with the cross-border trade of food and agriproducts.

The one or more inspection devices 104 are configured to interface seamlessly with the computer system 102, transmitting the collected photographic data efficiently and securely over the communication network 110. This is facilitated by the communication module within the computer system 102, which supports high-bandwidth and low-latency wireless connections to ensure the timely and accurate transfer of inspection data.

Each inspection device 104 is equipped with advanced imaging technology that allows inspectors to document the condition of goods in a manner that is suitable for subsequent AI analysis. These devices can operate in a variety of environmental conditions, often present in shipment and delivery locations, ensuring that inspectors can gather evidence that is comprehensive and representative of the goods' state.

The design of the one or more inspection devices 104 may also accommodate various ergonomic and operational considerations, such as ease of use, durability, and battery life, to support inspectors in conducting thorough and uninterrupted inspections. Furthermore, the inspection devices 104 may offer additional features such as geotagging, time-stamping, and secure data encryption, which contribute to the traceability, integrity, and authenticity of the inspection data collected.

Within the computer system 102 of the automated inspection report generation system 100, there is an embedded AI/ML module 1026. This module is integral to the system's capability to analyze photographic and IoT data for the generation of detailed inspection reports. The AI/ML module 1026 leverages sophisticated machine learning models that are pre-trained to interpret complex visual and sensor data, extracting meaningful insights to assess Quality, Quantity, and Weight (QQW) risks associated with the cross-border trade of food and agriproducts.

The AI/ML module 1026 employs a variety of machine learning techniques tailored to the specific demands of visual and data analysis within the context of inspection reports:
Neural Networks: Utilized for their proficiency in image recognition and pattern identification, neural networks are crucial for analyzing photographic data captured by the inspection devices. They can discern subtle differences in images that may indicate quality issues, quantify attributes of products, and detect anomalies.
Decision Trees: These are used for making structured decisions based on the integrated data, allowing the system to classify inspection findings into various quality categories or identify potential compliance issues with trade regulations.
Support Vector Machines (SVM): These are instrumental in classifying images and sensor data into predefined risk categories, assisting in the evaluation of whether the inspected goods meet the necessary quality standards.
Ensemble Methods: By combining the predictions of several machine learning models, techniques like Random Forests and Gradient Boosting ensure robustness and accuracy in the analysis of inspection data, leading to more reliable reports.
Clustering Algorithms: These algorithms, including K-Means and Hierarchical Clustering, are applied to group similar inspection cases together, aiding in the identification of common issues or trends across different inspections.
Anomaly Detection Algorithms: These algorithms play a key role in identifying unusual patterns or outliers in the integrated data that may signal significant deviations from expected quality measures or highlight potential risks not immediately apparent to human inspectors.
Foundational Models: These are versatile, large-scale models trained on extensive datasets that provide a robust foundation for various AI tasks. In risk assessment, foundational models can adapt to different types of data inputs, enhancing the system's ability to generalize and apply learned patterns across diverse scenarios in cross-border trade.
Large Language Models (LLMs): LLMs, such as GPT (Generative Pre-trained Transformer), are highly effective in processing and understanding natural language data. In the context of the risk assessment system, LLMs can analyze textual data from business communications and operational reports, extracting nuanced insights that contribute to a more accurate risk profile of the businesses involved.

The AI/ML module 1026, as a core element of the computer system 102, processes the photographic data received from the one or more inspection devices 104 and the IoT data from the IoT module 108. The AI/ML module's sophisticated algorithms transform this data into actionable insights, forming the basis of the comprehensive inspection reports that are critical for stakeholders in the cross-border trade of food and agriproducts. The machine learning techniques employed are chosen for their ability to provide in-depth and nuanced analysis, crucial for the accurate and reliable assessment of QQW risks in the traded goods.

As depicted in FIG. 1, the blockchain framework 112 is an integral component of the computer system 102 within the system for automated generation of AI-enabled inspection reports. The blockchain framework 112 provides a secure infrastructure that is fundamental to the integrity of the inspection process. It serves the vital function of recording inspection data and the results processed by the AI/ML module with unmatched fidelity. Central to this framework is an immutable ledger, which is crucial for validating the authenticity and precision of the data utilized in the generation of inspection reports.

The immutability of the blockchain ledger ensures that once inspection data or a report is recorded, it is resistant to alteration or erasure, thus offering a permanent and tamper-resistant record. This attribute is especially significant within the scope of generating inspection reports for cross-border trade, as it guarantees the dependability of data that signifies compliance with trade standards and product quality.

In addition to its immutability, the blockchain framework 112 offers several other key features in the present invention:
Decentralization: The blockchain ledger diverges from the traditional centralized database architectures by dispersing data across numerous nodes. This diminishes centralized data storage risks and augments the resilience of the system 100.
Transparency: The blockchain ensures that all recorded transactions are observable to network participants, promoting openness in the inspection process. This transparency is fundamental in fostering stakeholder trust and allows for the corroboration of data that underpin the inspection reports.
Security: Implementing cryptographic methods, the blockchain framework 112 secures data through encryption, thereby defending against unauthorized intrusions and potential security violations.
Traceability: Offering a verifiable audit trail, the blockchain framework 112 is instrumental for tracking the lineage of transactions and any alterations to data, thereby facilitating a meticulous and precise inspection process.

The incorporation of the blockchain framework 112 with the computer system 102, as showcased in FIG. 1, accentuates the invention's dedication to utilizing cutting-edge technology to refine the inspection reporting process. By furnishing a steadfast, transparent, and proficient method of data management, the blockchain framework 112 significantly bolsters the trustworthiness and efficiency of the system in the realm of cross-border trade inspections.

Furthermore, the computer system 102 is shown to interface with Internet of Things (IoT) module 108. The IoT module 108 significantly enhances the accuracy of inspections by aggregating real-time data from various sensor-based sources, which provide a multifaceted view of the shipment conditions, instrumental in assessing Quality, Quantity, and Weight (QQW) risks associated with the cross-border trade of food and agriproducts. Key IoT data sources that may be integrated into the IoT module 108 include, but are not limited to:
Temperature Sensors: Positioned within transportation vehicles or storage facilities, these sensors provide real-time data on the ambient temperature, crucial for perishable goods like food products.
Humidity Sensors Similar to temperature sensors, these are used to monitor moisture levels in the environment, particularly important for products sensitive to humidity.
GPS Trackers: Installed on shipping containers or vehicles, GPS trackers offer real-time location data, allowing for the tracking of goods in transit and ensuring they are following the intended routes.
Shock Sensors: These sensors detect and record instances of excessive force or impact that might occur during shipping, providing insights into the handling quality of the goods.
Light Exposure Sensors: Used to monitor the exposure of goods to light, particularly important for products sensitive to light and UV radiation.
RFID Tags: Radio-Frequency Identification tags on products or pallets provide data on inventory movement and can be used to verify the authenticity and origin of the goods.
Gas Sensors for Ethylene and CO₂ Emissions: These sensors are essential for monitoring the levels of ethylene and carbon dioxide, especially in the context of shipping perishable agricultural products. Ethylene gas sensors can detect the presence of this plant hormone, which is crucial for understanding the ripening and spoilage processes of fruits and vegetables during transit. Similarly, CO₂ sensors can monitor carbon dioxide levels, which are indicative of product respiration rates and overall freshness.

The integration of data from these sensors into the IoT module 108 adds another layer of precision in assessing the risk of spoilage and maintaining the quality of perishable goods throughout the supply chain. Additionally, the IoT module 108 may incorporate data from, but not limited to, touch sensors, heat sensors, infrared sensors, ultrasonic sensors, laser sensors, weight sensors, photoelectric sensors, pulse sensors, and light sensors. The integration of this data allows for the real-time collection and analysis of critical logistical parameters, such as temperature and humidity, which are pivotal for assessing spoilage risks during transit. Data from shock sensors are equally important as they provide insight into the handling and potential damage to the goods, which can affect the overall Quality, Quantity, and Weight (QQW) assessment.

Once this IoT data is collated, the computer system 102 processes it, correlating it with photographic data collected by the one or more inspection devices 104. The system's AI/ML module then analyzes this comprehensive dataset to evaluate potential operational risks, including product damage or spoilage and the efficacy of the delivery process. This in-depth analysis is vital to the automated generation of inspection reports, where diverse factors are meticulously considered and integrated to produce an accurate reflection of the inspected goods' condition.

The integration of IoT data not only elevates the precision of the inspection reports but also introduces a level of detail and accuracy that surpasses traditional inspection methods. By incorporating these real-time, logistical parameters, the system 100 provides an enriched and all-encompassing perspective on the risks present in cross-border trade of food and agriproducts.

The inclusion of such diverse, real-time data sources within the IoT module 108 exemplifies the innovative spirit of the present invention. By harnessing state-of-the-art technology, the system adeptly navigates the complexities of international trade inspections. Combined with the system's advanced AI analysis, secure blockchain data management, and wireless communication capabilities, this invention presents a comprehensive solution that markedly enhances the decision-making process for stakeholders in the global trade of food and agriproducts.

Additionally, there are one or more stakeholder devices 106 associated with stakeholders, as depicted in FIG. 1, are integral to the system for automated generation of AI-enabled inspection reports. Herein, the stakeholders may be, but not limited to, quality assurance inspectors, customs officials, and supply chain managers depend on the swift and reliable operation of the automated inspection report generation process. These stakeholder devices 106 may include a variety of computing devices, such as desktop PCs, laptops, PDAs, smartphones, tablets, wearable watches or bands, and other handheld devices. Each stakeholder device 106 is outfitted with microprocessors to facilitate processing and communication capabilities, allowing for a seamless interface with the computer system 102 primarily through wireless connections. These stakeholder devices 106 function not only as interfaces for report viewing and interaction but also may possess the capability to perform certain processing tasks, distributing the computational load and potentially enhancing the overall efficiency of the system.

In this embodiment, stakeholder devices 106 are required to be registered with the automated inspection report system to ensure secure and personalized interactions. The registration process involves these devices capturing and conveying critical details to the computer system 102, ranging from basic user identification information to more intricate data such as specific preferences and product details relevant to the inspection process. To bolster the security and reliability of the system, the registration may also entail biometric authentication, including fingerprint, facial, and iris recognition, among others, to restrict system access to verified users.

Incorporating registration and data management capabilities directly into the stakeholder devices 106 enhances the user experience by enabling swift and secure onboarding and authentication, which is vital in a system that processes sensitive inspection data. Moreover, by decentralizing these functions, the system 100 benefits from increased resilience and efficiency; each stakeholder device becomes a self-sufficient entity capable of managing its security protocols and data exchanges with the computer system 102, which is fundamental for maintaining the integrity and responsiveness of the automated inspection report generation process.

An additional embodiment of the present invention involves configuring the computer system 102 as part of a remotely distributed system, catering to the needs of automated inspection report generation. In this configuration, processing duties typically centralized within the computer system 102 might be executed on remote servers. This leverages cloud computing to offer scalable resources and handle extensive data sets efficiently—an asset when dealing with the intricate analysis required for AI-enabled inspection report generation.

Alternatively, processing responsibilities can be decentralized across the processors found within the one or more inspection devices 104 or stakeholder devices 106. This approach distributes the computational tasks across multiple nodes, enhancing system robustness by minimizing dependence on a singular processing hub. Such a distributed architecture could improve the system's agility and responsiveness, which is critical when generating real-time inspection reports and updating them as new IoT and photographic data are received.

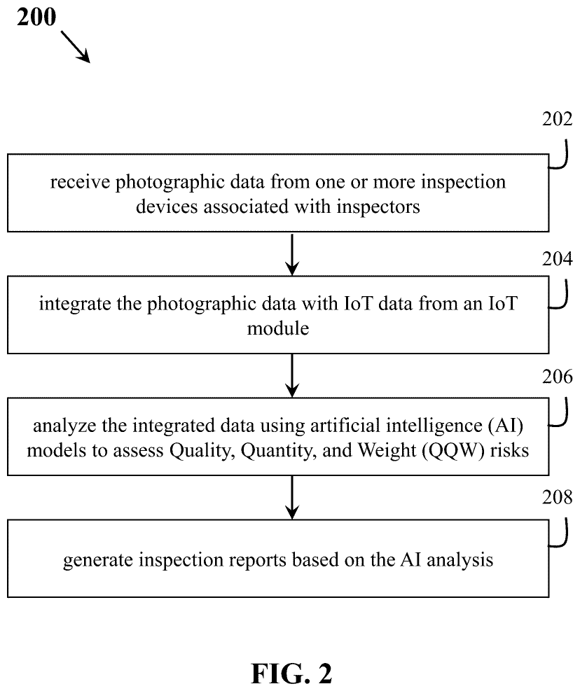

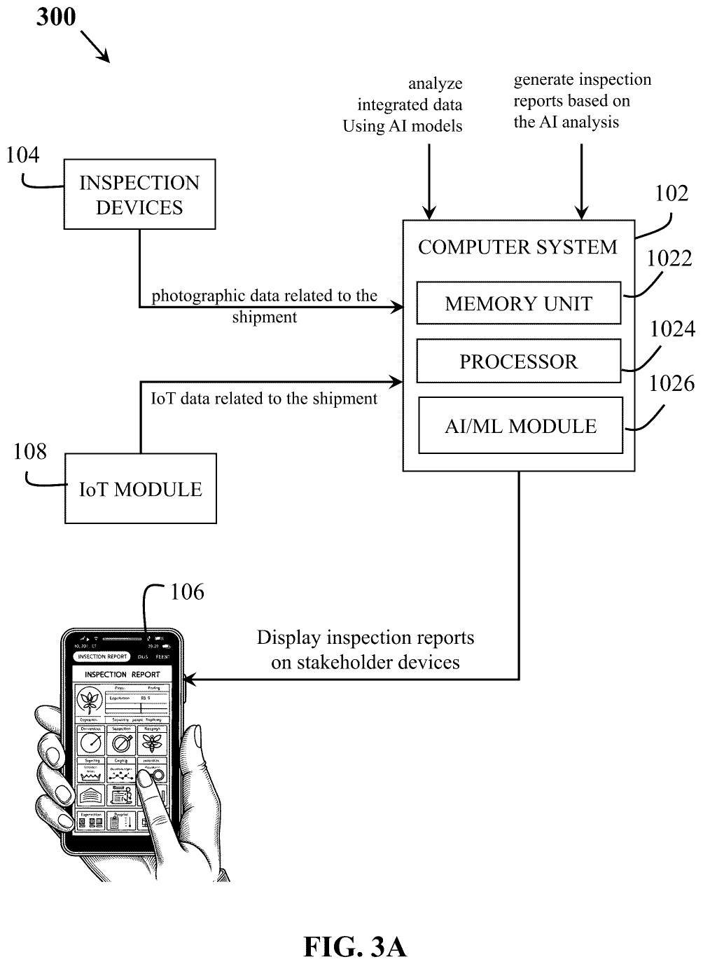

FIG. 2 illustrates a computer-implemented method 200 for automated generation of AI-enabled inspection reports for cross-border trade of food and agriproducts, in accordance with an embodiment of the present invention. However, the computer-implemented method 200 would be better understood in reference of FIG. 3, side by side. FIG. 3 illustrates an information flow diagram showcasing an exemplary implementation of the system 100 and method 200 of FIGS. 1 and 2, in accordance with an embodiment of the present invention. This will provide a clearer understanding of the operational intricacies and the innovative aspects of the present invention.

So, the computer implemented as shown in FIG. 2, includes:

Step 202 (Receiving Photographic Data): The computer-implemented method begins at Step 202, where the computer system 102 receives photographic data related to the shipment. This data, captured by inspection devices associated with inspectors, includes images and videos taken at shipment or delivery locations. This step is fundamental in gathering visual evidence, crucial for the subsequent steps in the inspection report generation process.

Step 204 (Integrating Photographic Data with IoT Data): Progressing to Step 204, the method involves the integration of the photographic data with IoT data, sourced from an IoT module. The IoT data typically encompasses various parameters like temperature, location, and humidity data, which are pivotal in assessing the condition of the goods during shipment. The integration of photographic and IoT data creates a rich dataset that provides a comprehensive view of the shipment's state, enhancing the accuracy of the subsequent inspection report.

Step 206 (Analyzing Integrated Data with AI Models): In Step 206, the computer system 102 utilizes AI/ML module 2026 comprising AI and ML models to analyze the integrated data. This step is crucial for assessing Quality, Quantity, and Weight (QQW) risks associated with the shipment. The AI models, incorporating advanced machine learning techniques, effectively process the combined data for image and pattern recognition. This allows the computer system 102 to derive meaningful insights from the photographic and IoT data, crucial for accurate inspection report.

Step 208 (Generating Inspection Reports): The final step, Step 208, involves the computer system 102 generating detailed inspection reports based on the AI analysis. These reports articulate the QQW risks, offering stakeholders critical information about the shipment's compliance and condition. This step represents the culmination of the computer-implemented method 200, translating complex data analysis into actionable reports.

In accordance with an embodiment of the present invention, the computer-implemented method 200 further involves capturing detailed images and videos at specific shipment and delivery locations to enrich the photographic data. The integrated data is then secured using a blockchain framework 112, ensuring the integrity and confidentiality of the information. This secured data is wirelessly transmitted to associated stakeholder devices 106, enabling easy access and review of the inspection reports.

In addition to the process described, the AI-enabled inspection reports generated by the system 100 encompass the following key contents, offering stakeholders a detailed and insightful overview of each shipment's condition and compliance, such as, but not limited to:
Photographic Analysis Summary: High-resolution images and videos captured by the inspection devices 104, analyzed by AI models for visual indicators of product quality and condition. This section would detail any observed anomalies or deviations from expected standards.
IoT Data Insights: Real-time data from IoT sensors, such as temperature, humidity, and location readings during shipment. This section would interpret how these conditions may have impacted the quality of the products.
QQW Assessment: A thorough evaluation of the quality, quantity, and weight of the products based on the integrated analysis of photographic data and IoT data. This section would include specifics on any detected discrepancies and their potential impact on product integrity.
Risk Scoring: A calculated risk score for each evaluated parameter (quality, quantity, and weight), providing a quantifiable measure of the potential risks associated with the shipment.
Recommendations: Based on the analysis, the report would offer actionable recommendations or corrective measures to mitigate any identified risks.
Blockchain Verification: A section detailing the blockchain framework 112's role in securing the data, ensuring the authenticity and integrity of the report.
Historical Data Comparison: If applicable, a comparison with historical data to track and highlight trends or recurring issues over time.
Stakeholder Summary: Customized insights for different stakeholders (e.g., exporters, importers, regulatory bodies) emphasizing the aspects most relevant to each party.
Graphical Representations: Visual graphs and charts for easier interpretation of complex data and trends.
Executive Summary: A concise overview of the key findings, risks, and recommendations for quick and effective decision-making

In accordance with an embodiment of the present invention, the computer-implemented method 200 also includes updating the inspection reports in real-time as new data becomes available, ensuring that stakeholders have access to the most current information. This real-time update is a critical aspect of the computer-implemented method 200, allowing for dynamic adjustments and timely decision-making Furthermore, the inspection reports are accessible via user interfaces on various stakeholder devices 106, ranging from laptops to mobile phones and wearable devices, facilitating efficient dissemination and review of the reports. This comprehensive approach, encompassing real-time updates and broad accessibility, significantly enhances the operational efficiency of the computer-implemented method 200 and supports data-driven decisions in the dynamic environment of cross-border trade.

In summation, the comprehensive sequence of method steps, from 202 to 208, as depicted in FIG. 2 and further elaborated through the information flow diagram in FIG. 3, effectively demonstrates the operational essence of the computer-implemented method 200 for generating AI-enabled inspection reports in cross-border trade of food and agriproducts. This methodical progression, from the initial gathering of photographic and IoT data to the final generation of detailed inspection reports, showcases a highly sophisticated and efficient process. The computer-implemented method 200 integrates advanced technological elements such as AI and machine learning for data analysis, a blockchain framework 112 for data security, and the innovative use of IoT data. These elements work in synergy to provide a comprehensive and accurate analysis of shipment quality, quantity, and weight risks.

The computer-implemented method's 200 capability to dynamically update and transmit inspection reports to associated stakeholder devices 106 highlights its responsiveness and user-centric design. This approach ensures that stakeholders, including inspectors, trade professionals, and regulatory bodies, have immediate access to vital inspection information. The use of various stakeholder devices 106 for report access, ranging from laptops to mobile phones, emphasizes the computer-implemented method's 200 adaptability and its alignment with modern technological standards. Overall, the integration of cutting-edge technologies with practical application makes this method a significant advancement in the domain of automated inspection report generation for international trade. It addresses the complexities involved in ensuring the quality and compliance of food and agriproducts in cross-border transactions, offering a data-driven, secure, and efficient solution.

To further simply the present invention for a skilled addressee, the present invention can be better understood with the help of a working example, which would showcase how it will work in a real-life scenario.

### Working Example

To demonstrate the practical application of the present invention, consider a hypothetical scenario involving a company, ‘GlobalFresh Exporters,’ located in the US, specializing in the export of fresh fruits and vegetables to various countries, including ‘NatureMarket,’ a retail chain in Spain.

Field Inspection and Data Collection: GlobalFresh Exporters, leveraging the computer-implemented method 200 of the present invention, initiates a shipment of oranges to NatureMarket. Inspectors equipped with digital cameras, as part of the inspection devices 104, visit the packing site at GlobalFresh Exporters. They meticulously capture photographic data of the oranges, focusing on their quality and packaging. Simultaneously, IoT devices embedded within the shipment containers record temperature and humidity data, critical for maintaining the freshness of the oranges during transit.

Data Integration and AI Analysis: The collected photographic data, along with the IoT data, is transmitted to the computer system 102 of the present invention. The system 100 integrates these data sets, creating a comprehensive profile of the shipment. Utilizing AI models, particularly image recognition algorithms, the system 100 analyzes the photographs for quality parameters such as color, size, and any signs of spoilage or damage. Concurrently, the AI models assess the IoT data to ensure the environmental conditions during transit are optimal for orange preservation.

Blockchain Security and Report Generation: As the integrated data is analyzed, the blockchain framework 112 of the system 100 secures this information, creating a tamper-proof and reliable record. The computer system 102 then automatically generates a detailed inspection report. This report includes visual evidence from the photographs, environmental data from the IoT devices, and AI-driven analysis, offering an in-depth assessment of the shipment's quality, quantity, and weight (QQW) risks.

Real-time Updates and Stakeholder Access: Upon report generation, NatureMarket, as a stakeholder, receives an immediate update. Utilizing their mobile devices, representatives from NatureMarket can access the inspection report through a user interface. The report provides them with a clear, data-driven view of the shipment's condition, significantly reducing reliance on manual inspection methods and minimizing the potential for human error.

Dynamic Adaptation and Decision Making: The system's 100 capability to update reports in real time as new data is received allows GlobalFresh Exporters and NatureMarket to continuously monitor the shipment. Any changes in the shipment's condition, detected through ongoing IoT data analysis, are promptly reflected in updated reports, ensuring both parties have the latest information. This feature is particularly valuable when unexpected changes in shipment conditions occur, such as fluctuations in temperature or humidity levels.

Utilization in Future Transactions: Armed with the comprehensive and reliable inspection reports generated by the system 100, NatureMarket gains confidence in the quality of produce received from GlobalFresh Exporters. This confidence bolsters their business relationship, encouraging repeat transactions. For GlobalFresh Exporters, the ability to provide instant, detailed, and AI-validated inspection reports becomes a key differentiator in the market, enhancing their reputation as a reliable supplier.

Adaptation to Business Needs: As new varieties of produce are added to GlobalFresh Exporters' export list, the system's 100 flexible AI models adapt to analyze different types of fruits and vegetables, maintaining the accuracy and relevance of the inspection reports. The system's 100 scalability allows GlobalFresh Exporters to expand its use to other product lines, facilitating growth and diversification.

To summarize, this working example highlights the efficiency and effectiveness of the computer-implemented method 200 in providing accurate, AI-enabled inspection reports for cross-border trade of food and agriproducts. The integration of photographic data analysis with IoT data, secured by a blockchain framework 112 and presented in real-time to stakeholders, exemplifies a significant advancement in ensuring the quality and compliance of products in international trade. The computer-implemented method's 200 adaptability, precision, and user-centric design make it an invaluable tool for businesses like GlobalFresh Exporters and NatureMarket, streamlining their trade processes and enhancing decision-making with data-driven insights.

As detailed above, the present invention focuses on automated generation of AI-enabled inspection reports for cross-border trade of food and agriproducts, are numerous and significant, and therefore offers numerous and significant advantages:
Enhanced Accuracy: Utilizing AI to analyze photographic data and IoT device readings reduces human error in inspections, leading to more accurate and reliable reports.
Real-time Data Utilization: The integration of real-time IoT data, such as temperature and humidity readings, provides up-to-date information on shipment conditions, crucial for maintaining product quality during transit.
Comprehensive Risk Assessment: By combining photographic data with IoT data, the system offers a holistic view of Quality, Quantity, and Weight (QQW) risks, ensuring thorough inspections and detailed risk evaluation.
Efficiency and Speed: Automated report generation speeds up the inspection process, allowing for instant report availability. This rapid turnaround is crucial in time-sensitive trading scenarios.
Reduced Human Error: AI and IoT integration minimizes the likelihood of mistakes that can occur in manual inspections, resulting in more consistent and dependable assessments.
Data-Driven Insights: The AI algorithms provide deeper, more nuanced insights based on objective data rather than subjective human observations.
Blockchain Secured Data: Utilizing blockchain technology ensures the security and integrity of inspection data, enhancing trust among stakeholders in the authenticity of the reports.
Scalability and Adaptability: The system can easily adapt to different scales of operations and is capable of handling a vast array of products, making it versatile for various business needs.
User-Friendly Access: Inspection reports can be accessed easily via user interfaces on stakeholder devices, facilitating quick decision-making and accessibility.
Traceability and Compliance: The system provides a transparent audit trail of the inspection process, ensuring compliance with international trade regulations and standards.
Customizable Reporting: The ability to tailor reports to specific stakeholder needs allows for targeted information dissemination, enhancing the utility of the reports.
Cost-Effectiveness: Over time, the automation and accuracy of the system can lead to cost savings by reducing the need for extensive manual labor and minimizing losses due to undetected shipment issues.

These advantages collectively contribute to a more efficient, reliable, and transparent process for generating inspection reports in the cross-border trade of food and agriproducts, ultimately enhancing the quality and safety of these traded goods.

In general, the word “module,” as used herein, refers to logic embodied in hardware or firmware, or to a collection of software instructions, written in a programming language, such as, for example, Java, C, or assembly. One or more software instructions in the modules may be embedded in firmware, such as an EPROM. It will be appreciated that modules may comprised connected logic units, such as gates and flip-flops, and may comprise programmable units, such as programmable gate arrays or processors. The modules described herein may be implemented as either software and/or hardware modules and may be stored in any type of computer-readable medium or other computer storage device.

Further, while one or more operations have been described as being performed by or otherwise related to certain modules, devices or entities, the operations may be performed by or otherwise related to any module, device or entity. As such, any function or operation that has been described as being performed by a module could alternatively be performed by a different server, by the cloud computing platform, or a combination thereof. It is implied that the techniques of the present disclosure might be implemented using a variety of technologies. For example, the methods described herein may be implemented by a series of computer executable instructions residing on a suitable computer readable medium. Suitable computer readable media may include volatile (e.g., RAM) and/or non-volatile (e.g., ROM, disk) memory, carrier waves and transmission media. Exemplary carrier waves may take the form of electrical, electromagnetic or optical signals conveying digital data steams along a local network or a publicly accessible network such as the Internet.

Further, the operations need not be performed in the disclosed order, although in some examples, an order may be preferred. Also, not all functions need to be performed to achieve the desired advantages of the disclosed system and method, and therefore not all functions are required.

The terms and descriptions used herein are set forth by way of illustration only and are not meant as limitations. Examples and limitations disclosed herein are intended to be not limiting in any manner, and modifications may be made without departing from the spirit of the present disclosure. Those skilled in the art will recognize that many variations are possible within the spirit and scope of the disclosure, and their equivalents, in which all terms are to be understood in their broadest possible sense unless otherwise indicated.

Various modifications to these embodiments are apparent to those skilled in the art from the description and the accompanying drawings. The principles associated with the various embodiments described herein may be applied to other embodiments. Therefore, the description is not intended to be limited to the embodiments shown along with the accompanying drawings but is to be providing broadest scope of consistent with the principles and the novel and inventive features disclosed or suggested herein. Accordingly, the invention is anticipated to hold on to all other such alternatives, modifications, and variations that fall within the scope of the present invention and the appended claims.

1. A system for automated generation of AI-enabled inspection reports for cross-border trade of food and agriproducts, the system comprising:
one or more inspection devices associated with inspectors;
an Internet of Things (IoT) module to gather shipment related data as IoT data;
a blockchain framework for securing all data; and
a computer system connected with the one or more inspection devices, the IoT module and the blockchain framework, the computer system including:
a processor; and
a memory unit configured to store machine readable instructions that, when executed by the processor, cause the computer system to:
receive photographic data related to the shipment from the one or more inspection devices;
integrate the photographic data with IoT data;
analyze the integrated data using artificial intelligence (AI) models to assess Quality, Quantity, and Weight (QQW) risks; and
generate inspection reports based on the AI analysis.

2. The system of claim 1, wherein the one or more inspection devices are selected from a group comprising digital cameras and video recorders.

3. The system of claim 1, wherein the IoT data includes at least temperature, location, and humidity data collected during shipment.

4. The system of claim 1, wherein the blockchain framework comprises an immutable ledger configured to securely log inspection data.

5. The system of claim 1, wherein the AI models include image recognition algorithms configured to analyze photographic data.

6. The system of claim 1, wherein the generated inspection reports are configured to detail the QQW risks for stakeholders in the cross-border trade.

7. The system of claim 1, wherein the computer system further comprises a communication module configured to transmit the integrated data and inspection reports wirelessly.

8. The system of claim 1, wherein the computer system is further configured to update the inspection reports in real-time as new data is received.

9. The system of claim 1, wherein the inspection reports are configured to be accessed via user interfaces on associated stakeholder devices.

10. The system of claim 9, wherein the stakeholder devices are selected from a group comprising laptops, mobile phones, wearable watches or bands, desktop computers, and portable handheld devices with computing capabilities.

11. A computer-implemented method for automated generation of AI-enabled inspection reports for cross-border trade of food and agriproducts, the computer-implemented method comprising:
receiving photographic data related to the shipment from one or more inspection devices associated with inspectors;
integrating the photographic data with IoT data from an IoT module;
analyzing the integrated data using artificial intelligence (AI) models to assess Quality, Quantity, and Weight (QQW) risks; and
generating inspection reports based on the AI analysis.

12. The computer-implemented method of claim 11, wherein receiving photographic data includes capturing images and videos at shipment or delivery locations.

13. The computer-implemented method of claim 11, wherein the IoT data includes at least temperature, location, and humidity data.

14. The computer-implemented method of claim 11, further comprising securing the integrated data using a blockchain framework.

15. The computer-implemented method of claim 11, wherein analyzing the integrated data includes using machine learning techniques for image and pattern recognition.

16. The computer-implemented method of claim 11, wherein generating inspection reports includes detailing the assessed QQW risks.

17. The computer-implemented method of claim 11, further comprising wirelessly transmitting the integrated data and inspection reports to associated stakeholder devices.

18. The computer-implemented method of claim 11, further comprising updating the inspection reports in real-time as new data is received.

19. The computer-implemented method of claim 11, further comprising accessing the inspection reports via user interfaces on associated stakeholder devices.

20. The computer-implemented method of claim 19, wherein the associated stakeholder devices are selected from a group comprising laptops, mobile phones, wearable watches or bands, desktop computers, and portable handheld devices with computing capabilities.
